(19) United States
(12) Patent Application Publication
(10) Pub. No.: US 2024/0153370 A1
(43) Pub. Date: May 9, 2024

(54) THREAT DATA ANALYZER

(71) Applicants: Keith J. Johanns, Dublin, OH (US); Nicolas P. Bons, Ogden, UT (US); Patrick A. Green, Glenwood, MD (US); Patrick Alan Loney, Fairview Park, OH (US)

(72) Inventors: Keith J. Johanns, Dublin, OH (US); Nicolas P. Bons, Ogden, UT (US); Patrick A. Green, Glenwood, MD (US); Patrick Alan Loney, Fairview Park, OH (US)

(73) Assignee: NORTHROP GRUMMAN SYSTEMS CORPORATION, FALLS CHURCH, VA (US)

(21) Appl. No.: 17/980,916

(22) Filed: Nov. 4, 2022

(51) Int. Cl. G08B 21/12; G01S 7/285

(52) U.S. Cl. CPC G08B 21/12; G01S 7/285

(57) ABSTRACT

A threat analyzer receives threat data measured by detectors. The threat data characterizes a status of detected emissions for a corresponding detector. The threat analyzer analyzes the threat data to identify a geographic region that contains a threat to humans and stores the threat data and analyzed data in a database. The machine readable instructions also include a graphical user interface (GUI) generator that provides an interactive map with indicia that characterizes the analyzed threat data.

### TECHNICAL FIELD

The present disclosure relates to analyzing threat data received from detectors.

### BACKGROUND

The Internet of things (IoT) is a system of interrelated computing devices, mechanical and digital machines that are provided with unique identifiers (UIDs) and the ability to transfer data over a network without requiring human-to-human or human-to-computer interaction. The definition of the IoT has evolved due to the convergence of multiple technologies, real-time analytics, machine learning, commodity sensors and embedded systems. Fields of embedded systems, wireless sensor networks, control systems, automation (including home and building automation) and others all contribute to enabling the IoT.

In some situations, certain types of emissions can be harmful to humans. For example, pulsed radio frequency (RF) emissions at particular frequencies (e.g., microwaves) may harm humans if the humans receive such pulsed RF emissions for an extended period of time. Further, exposure to radiation emissions from a source, such as enriched uranium have been shown to be harmful to humans. Further, exposure to emissions of poisonous gas are harmful to humans.

### SUMMARY

One example relates to a system for monitoring operations of a computing platform. The system includes a non-transitory memory for storing machine readable instructions and a processing unit that accesses the memory and executes the machine readable instructions. The machine readable instructions include a threat analyzer that receives threat data measured by detectors. The threat data characterizes a status of detected emissions for a corresponding detector. The threat analyzer analyzes the threat data to identify a geographic region that contains a threat to humans and stores the threat data and analyzed data in a database. The machine readable instructions also include a graphical user interface (GUI) generator that provides an interactive map with indicia that characterizes the analyzed threat data.

Another example relates to a non-transitory machine readable medium having machine executable instructions executable by a processing unit. The machine executable instructions include a threat analyzer that receives threat data measured by stationary detectors and wearable detectors. The threat data characterizes a status of detected emissions for a corresponding stationary detector or a corresponding mobile detector and analyzes the threat data to identify a geographic region that contains a threat to humans. The threat analyzer stores the threat data and analyzed data in a database. The machine readable instructions also include a GUI generator that provides an interactive map with indicia that characterizes the analyzed threat data.

Yet another example relates to a method that includes receiving, at a computing platform, threat data measured by stationary detectors and mobile detectors, wherein the threat data characterizes a status of detected emissions for a corresponding stationary detector or a corresponding mobile detector. The method also includes analyzing, by the computing platform, the threat data to identify a geographic region that contains a threat to humans and to determine a signature of the threat. The method further includes storing, by the computing platform, the threat data and analyzed data in a database. Additionally, the method includes outputting, by the computing platform, a dashboard that provides an interactive map with indicia that characterizes the analyzed threat data.

### BRIEF DESCRIPTION OF THE DRAWINGS

FIG. 1 illustrates a block diagram of a system for monitoring the presence or absence of a threat to humans.

FIG. 2 illustrates a wearable detector for detecting emissions from a threat.

FIG. 3A illustrates a first screenshot for a threat detection application executing on a mobile device.

FIG. 3B illustrates a second screenshot for a threat detection application executing on a mobile device.

FIG. 3C illustrates a third screenshot for a threat detection application executing on a mobile device.

FIG. 4A illustrates a first screenshot of a dashboard generated by a graphical user interface (GUI) generator.

FIG. 4B illustrates a second screenshot of the dashboard generated by a graphical GUI generator.

FIG. 4C illustrates a third screenshot of the dashboard generated by a graphical GUI generator.

FIG. 4D illustrates a fourth screenshot of the dashboard generated by a graphical GUI generator.

FIG. 4E illustrates a fifth screenshot of the dashboard generated by a graphical GUI generator.

FIG. 4F illustrates a fifth screenshot of the dashboard generated by a graphical GUI generator.

FIG. 5 illustrates an example of a method for monitoring for the presence or absence of a threat.

### DETAILED DESCRIPTION

This disclosure relates to systems and methods for detecting emissions that pose a threat to humans, such as microwave emissions, nuclear radiation, toxic chemicals, etc. Some of the detectors are implemented as stationary detectors, and other detectors are implemented as wearable (e.g., mobile) detectors, such that are integrated into business articles such as badge holders, lanyards, etc. In examples where the detectors are wearable detectors, the detectors communicate with an application (e.g., an app) operating on a mobile computing device (e.g., a smart phone). The application periodically and/or asynchronously pings the detector for a current state of detected emission. The application stores the pinged results along with a timestamp.

The applications executing on the mobile devices that communicate with the wearable detectors can be referred to as threat detection applications. These threat detection applications communicate with a server that executes a threat analyzer (e.g., an information management system). The threat detection applications periodically and/or asynchronously upload data characterizing the current state of detected emissions from the detectors to the server, which data can be referred to as threat data. Additionally, the stationary detectors can communicate with the information management system directly and provide similar information. In response to receipt of the data, the threat analyzer collates the data to determine if a threat is present and can store the data in a database (or other data structure). Additionally, the server provides a graphical user interface (GUI), such as a dashboard (e.g., a webpage) that includes an interactive map characterizing a current and historical status of the threat.

The interactive map provides indicia (e.g., color coded icons) that indicate a status of detectors in a particular geographic region. For instance, a green icon might indicate that the corresponding detector does not detect a threat withing a given timeframe. Conversely, a red icon might indicate that the corresponding detector has detected emissions indicative of a threat in examples where a threat is detected, each o the following (or some combination thereof) can occur; (i) increased duration and/or rate of the sampling, (ii) increased sensitivity of the dynamic range, or (iii) additional sensors brought on line within fielded device as available and/or as needed.

The threat analyzer can analyze the data characterizing detected threats to identify a signature for a particular threat. As a given example, suppose that a given threat is a microwave emitter. In this instance, the signal detected by each corresponding detector would have the same pulse width, frequency and amplitude, indicating that the signal detected by the detectors originated from the same source. This information, along with the information employ to generate the interactive map is stored in the database. Accordingly, this information is employable in forensics to determine a source of the emission and/or a time of the emissions (or a source and time of the threat, more generally). In situations where the time of the emissions is known, surveillance systems that include surveillance equipment (e.g., cameras) within the vicinity of the detectors detecting the threat can be queried to improve the chances that a source of the emissions can be identified.

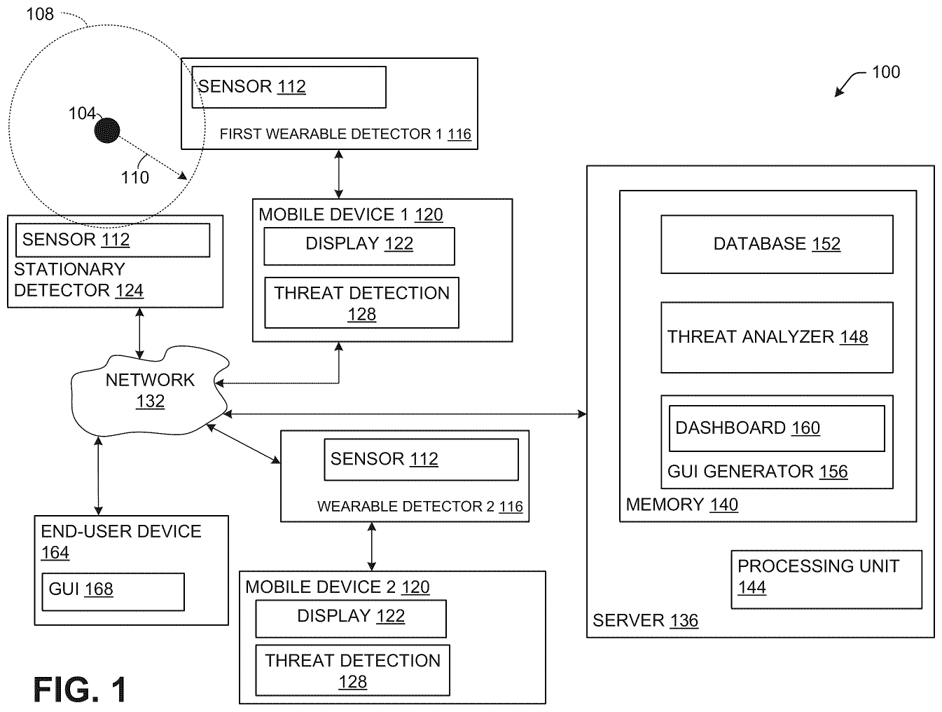

FIG. 1 illustrates a block diagram of a system 100 that monitors threat data to identify a presence of a threat 104 to humans. As used herein, the term “threat” refers to emissions or exposures that can cause harm to humans. The threat 104 represents an emitter. For example, the threat 104 can represent a source of radio frequency (RF) emissions, such as pulsed emissions with a frequency of about 150 megahertz (MHz) to about 1.5 gigahertz (GHz). In other examples, the threat 104 can represent a source of radiation or a source of poisonous gas.

The threat 104 has a radius of harm 108. The radius of harm 108 represents a radial distance 110 from the threat 104. In the examples discussed, for simplicity, it is presumed that the threat 104 is omnidirectional and has such a radius of harm 108 (e.g., a circle). However, in some examples, such as RF emissions, the threat 104 can be directional and can provide emissions in a different shape.

The emissions from the threat 104 are detectable by sensors 112. The sensors 112 are designed as physical sensors to detect a particular type of threat, such as the RF emissions, radiation and/or poisonous gas. Thus, in various examples, the sensors 112 are implemented as antennas, Geiger counters or a semiconductor circuit configured to detect poisonous gas.

A first subset of the sensors 112 are integrated with a corresponding wearable detector 116 (e.g., a mobile detector). In the example illustrated, there are two wearable detectors 116, namely a first wearable detector 116 (labeled “WEARABLE DETECTOR 1”) and a second wearable detector 116 (labeled “WEARABLE DETECTOR 2”). The wearable detectors 116 could be implemented, for example with a lanyard and identification card, a lapel pin, etc. The wearable detectors 116 communicate wirelessly with a corresponding mobile device 120, namely a first mobile device 120 (labeled “MOBILE DEVICE 1”) and a second mobile device 120 (labeled “MOBILE DEVICE 2”). In other examples, there could be more wearable detectors 116 and more mobile devices 120. The wearable detectors 116 can be implemented, as a microcontroller, such as Internet of Things (IoT) devices, and the mobile devices 120 can be implemented as computing platforms, such as smart phones, tablet computers, etc. Thus, the corresponding wearable detectors 116 can wirelessly communicate with the corresponding mobile device 120, such as through the Bluetooth protocol.

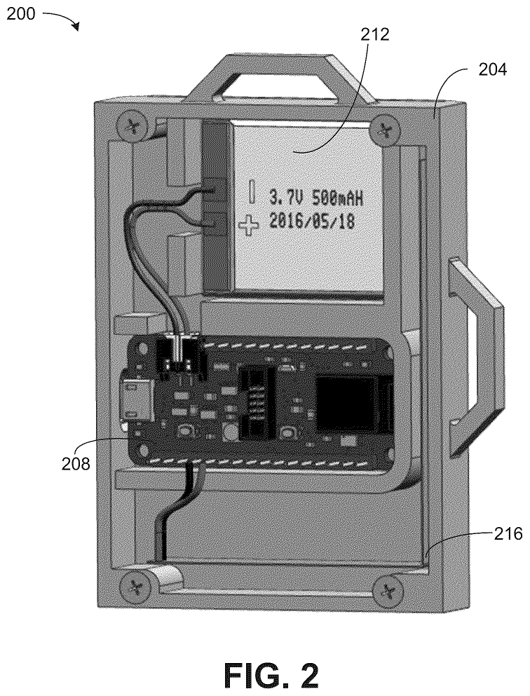

FIG. 2 illustrates an example of a wearable detector 200 that is employable to implement one of the wearable detectors 116 of FIG. 1. The wearable detector 200 includes a casing 204 that is shaped similar to an identification badge holder. In the example illustrated, a side of the casing 204 has been removed for visibility. The wearable detector 200 includes a microcontroller 208 (e.g., an IoT device). The wearable detector 200 includes a battery 212 (or other energy storage element) that provides power to the microcontroller 208.

In the example illustrated, the wearable detector 200 is configured to detect RF emissions. Thus, the wearable detector 200 includes an antenna 216 that implements a sensor (e.g., a sensor 112 of FIG. 1). In other examples, other types of sensors are employable in place of the antenna 216. The antenna 216 is coupled to an input port of the microcontroller 208. The microcontroller 208 includes embedded operations for communicating wirelessly with a mobile device, such as one of the mobile devices 120 of FIG. 1.

Referring back to FIG. 1, a second subset of the sensors 112 are implemented on a stationary detector 124. In the example provided, only one stationary detector 124 is illustrated, but in other examples, there could be multiple stationary detectors 124. The stationary detector 124 can be implemented with a microcontroller, such as an IoT device. In some examples, the stationary detector 124 is situated (e.g., installed) at a known permanent (or semipermanent) location.

The stationary detector 124 and the wearable detectors 116 can each be configured to periodically and/or asynchronously measure emissions and record a timestamp for the measurement, which can be referred to as threat data. In some examples, the stationary detector 124 and/or the wearable detectors 116 are configured to detect one type of emissions and/or exposure that poses a threat to humans, and in other examples, the stationary detector 124 and/or the wearable detectors 116 are configured to detect multiple types of emissions and/or exposure that pose a threat to humans. Additionally, the mobile devices 120 include a display 122, such as a touch screen display to allow user interaction. The mobile devices 120 can also execute application software (e.g., apps). More particularly, the mobile devices 120 can execute a threat detection application 128. The threat detection application 128 can be configured to periodically and/or asynchronously query (e.g., ping) the corresponding sensor 112 for the threat data. Additionally, the threat detection application 128 can query the mobile devices 120 for location data (e.g., latitude and longitudinal coordinates), which can be added to threat data.

The threat data includes data for a signature for detected emissions (if any). The signature for the emissions varies based on the type of sensor 112 employed. For instance, if the sensors 112 are implemented as antennas, such that the stationary detector 124 and the wearable detectors 116 are configured to detect RF emissions, the threat data includes a frequency and a pulse width of the RF emissions, which taken in combination can uniquely identify the threat 104. Conversely, in examples where the sensors 112 are implemented as Geiger counters configured to detect radioactive activity, the threat data can include a time variance of detected radiation emissions.

The stationary detector 124 and the threat detection application 128 of the mobile devices 120 can communicate on a network 132. The network 132 can be implemented, for example, on a public network (e.g., the Internet), a private network (e.g., a cellular network) or a combination thereof. More particularly, the stationary detector 124 and the mobile devices 120 can communicate with a server 136 that also communicates on the network 132. The communication can be executed with a protocol that is agnostic to the particular type of sensors 112 employed.

The server 136 can be implemented as a computing platform. Thus, the server 136 can include non-transitory memory 140 (e.g., a computer readable medium) that can store machine readable instructions and data. The non-transitory machine readable memory 140 can be implemented, for example, as volatile or nonvolatile random access memory (RAM), such as flash memory, a hard-disk drive, a solid state drive or a combination thereof. The processing unit 144 (e.g., one or more processor cores) can access the memory 140 and execute the machine-readable instructions.

The server 136 could be implemented in a computing cloud. In such a situation, features of the server 136, such as the processing unit 144, a network interface to communicate on the network 132, and the memory 140 could be representative of a single instance of hardware or multiple instances of hardware with applications executing across the multiple of instances (i.e., distributed) of hardware (e.g., computers, routers, memory, processors, or a combination thereof). Alternatively, the server 136 could be implemented on a single dedicated server.

The memory 140 can include a threat analyzer 148 that communicates with a database 152 and graphical user interface (GUI) generator 156. The stationary detector 124 and the threat detection applications 128 operating on the mobile devices 120 can provide threat data to the threat analyzer 148. The threat analyzer 148 stores the threat data in the database 152. Additionally, the threat analyzer 148 controls the GUI generator 156 causing the GUI generator 156 to provide a dashboard 160 (e.g., a webpage) that is accessible by an end-user device 164.

The end-user device 164 is implemented as a computing platform, such as a desktop computer, a laptop computer, a server, a tablet computer, a smartphone, etc. The end-user device 164 includes a GUI 168 (e.g., a web browser) that allows for user interaction. Additionally, although the end-user device 164 and the mobile devices 120 are illustrated as being separate devices, in some examples, the end-user device 164 and the mobile devices 120 (that communicates with a wearable detector 116) can be integrated on a single device. More particularly, the GUI 168 can display the dashboard 160 generated by the GUI generator 156, and allow a user of the end-user device 164 to interact with the dashboard (e.g., press virtual buttons, enter user input, etc.).

The threat analyzer 148 monitors the threat data to determine if an active threat is detected. In situations where the threat data from the stationary detector 124 and the wearable detectors 116 indicate that no emissions (or emissions below a threshold) are detected, the threat analyzer 148 can determine that no current threat is being detected. In some examples, there are hundreds or thousands of wearable detectors 116 and/or stationary detectors 124 geographically distributed throughout the earth (e.g., at working facilities). Thus, in situations where no threat is detected, it is presumed that none of the geographically distributed wearable detectors 116 or the stationary detector 124 are detecting emissions that would be indicative of a threat. In this situation, the threat analyzer 148 provides the GUI generator 156 with data indicating that no threat is detected, and the dashboard 160 provides information to the user of the end-user device 164 indicating as such. Furthermore, in situations where no threat is detected, the threat detection application 128 of the mobile devices 120 and the stationary detector 124 can record sensed emissions at a first measurement sensitivity level to conserve battery life of the wearable devices 116 and the mobile devices 120.

In converse to a situation where no threat is detected in the example illustrated, the sensor 112 of the first wearable detector 116 and the sensor 112 of the stationary detector 124 are shown as being located within the radius of harm 108 of the threat 104. Thus, in the example illustrated, the threat data provided by the first mobile device 120 and the stationary detector 124 include data characterizing the signature of the threat 104. Additionally, in the example illustrated, the sensor 112 of the second wearable detector 116 does not detect the threat 104 because the second wearable detector 116 is outside the radius of harm 108 of the threat 104.

Thus, in the illustrated example, the threat data from the first mobile devices 120 and the stationary detector 124 indicates that emissions are detected, and includes a signature characterizing the emissions. In response, the threat analyzer 148 can store the threat data (including a location of the first mobile device 120 and the stationary detector 124) in the database 152. Additionally, the threat detection application 128 of the first mobile device 120 and the stationary detector 124 can increase the measurement sensitivity level of recording detected emissions from a first level to a second level improve a resolution (e.g., timeliness and/or accuracy) of the threat data.

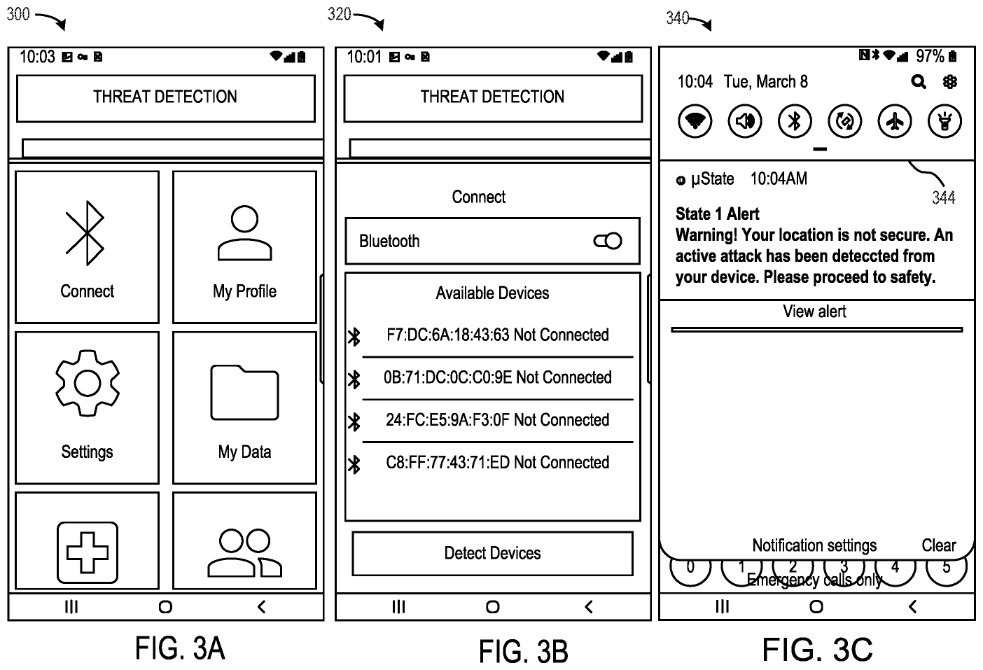

Additionally, the threat analyzer 148 can provide a notification to the threat detection application 128 of the first mobile device 120 that the threat 104 has been detected. In response, the threat detection application 128 of the first mobile device 120 outputs a notification on the display 122. FIGS. 3A-3C illustrate example screenshots output by the threat detection application 128.

More specifically, FIG. 3A illustrates a first screenshot 300 of a threat detection application (e.g., the threat detection application 128 of FIG. 1) executed by a mobile device (e.g., the first mobile device 120 of FIG. 1) showing a dashboard with selectable operations (e.g., virtual buttons). FIG. 3B illustrates a second screenshot 320 of the threat detection application that lists wearable detectors (e.g., the wearable detectors 116 of FIG. 1) that are communicating with the mobile device executing the threat detection application. FIG. 3C illustrates a third screenshot 340 of the threat detection application that provides a notification 344 with text explaining that a threat (e.g., the threat 104 of FIG. 1) was detected by the corresponding wearable detector (e.g., the first wearable detector 116).

Referring back to FIG. 1, additionally, in response to the threat data indicating that a threat has been detected, the threat analyzer 148 also identifies a subset of wearable detectors 116 and/or stationary detectors 124 that are proximate to the first wearable detector 116 and/or the stationary detector 124, or to any other wearable detectors 116 and/or stationary detector 124 that detected emissions indicative of a threat. The proximate distance varies in range based on the type of threat 104, such that the proximate distance can be 10 meters or less in some examples, and in other examples, the proximate distance can be one kilometer or more. This subset of wearable detectors 116 and/or stationary detectors 124 is provided a notification indicating that a threat has been detected in the proximate area. In response to this notification, the receiving threat detection application 128 increases a measurement sensitivity level for the wearable detectors 116 from a first level to a second level. In a similar manner, the stationary detector 124 increases its measurement sensitivity level.

Increasing the measurement sensitivity level of the subset of wearable detectors 116 and/or stationary detectors 124 increases an accuracy of the measurements taken. In a first example, suppose that the threat 104 is an RF emitter. In this first example, increasing the measurement sensitivity level (e.g., sensitivity of a dynamic range) from the first level to the second level causes the threat detection application 128 or the stationary detector 124 to increase a measurement rate (alternatively referred to as a ping rate) of the sensors 112 from the first rate (a first level; e.g., once per second to once per 10 minutes) to a second rate (a second level; e.g., a rate greater than the first rate) to improve a resolution (e.g., timely accuracy) of the threat data. In a second example, suppose that the threat 104 is a source of poisonous gas. In this second example, the first level of the measurement sensitivity could cause the sensors 112 of the subset of wearable detectors 116 and/or stationary detectors 124 to report a detection of any poisonous gas. In a second level of the measurement sensitivity in the second example, the subset of wearable detectors 116 and/or stationary detectors 124 can cause the sensors 112 to measure and report detection of specific types of poisonous gas. In a third example, suppose that the threat 104 is a source of radiation emissions. In this second example, the first level of measurement sensitivity could cause the sensors 112 of the subset of wearable detectors 116 and/or stationary detectors 124 to measure any type of detected radiation. In a second level of measurement sensitivity in the second example, the subset of wearable detectors 116 and/or stationary detectors 124 can cause the sensors 112 to measure and report specific types of radiation, such as alpha, beta and gamma particles. In other examples, other types of operations can be changed to increase the measurement sensitivity level. Additionally, the threat detection application 128 causes the corresponding display 122 to output a warning that a proximal threat (e.g., the threat 104 has been detected). In a first example, the threat detection application 128 of the second mobile device 120 receives the notification. In a second example, the second mobile device 120 is presumed not to be proximate to the first wearable detector 116 and/or the stationary detector 124, such that the threat analyzer 148 does not provide the threat detection application 128 of the second mobile device 120 with the notification, and the operations of the threat detection application 128 of the second mobile device 120 would be unchanged.

At some point in the future, the threat 104 is ceased, and the threat data from the wearable detectors 116 and/or the stationary detector 124 no longer indicates that a threat is detected. In this situation, the threat analyzer 148 provides an indication to the threat detection application 128 of the mobile devices 120 that no threats are detected, and that the measurement sensitivity level can be reduced to the first level to conserve battery life of the wearable detectors 116 and the mobile devices 120.

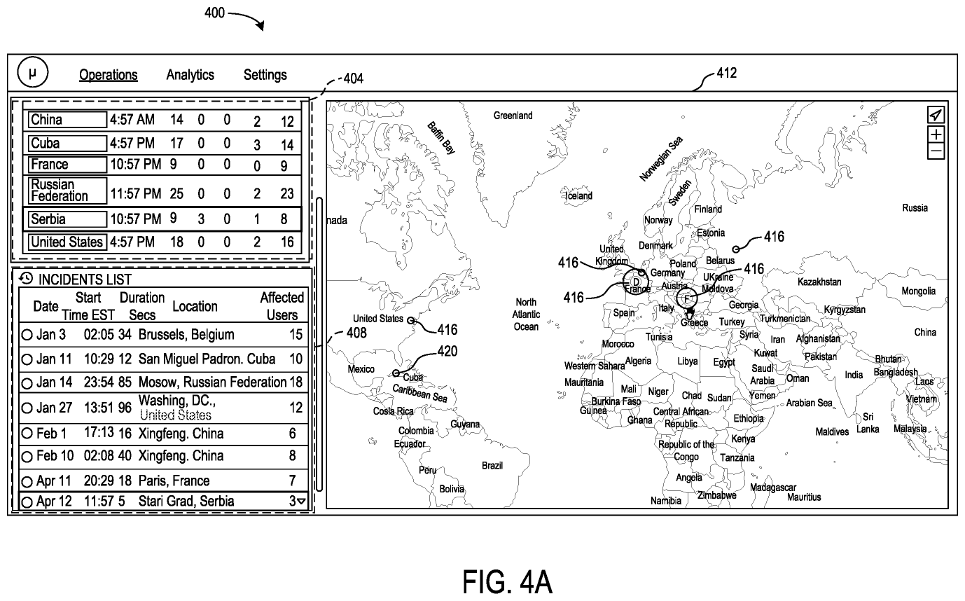

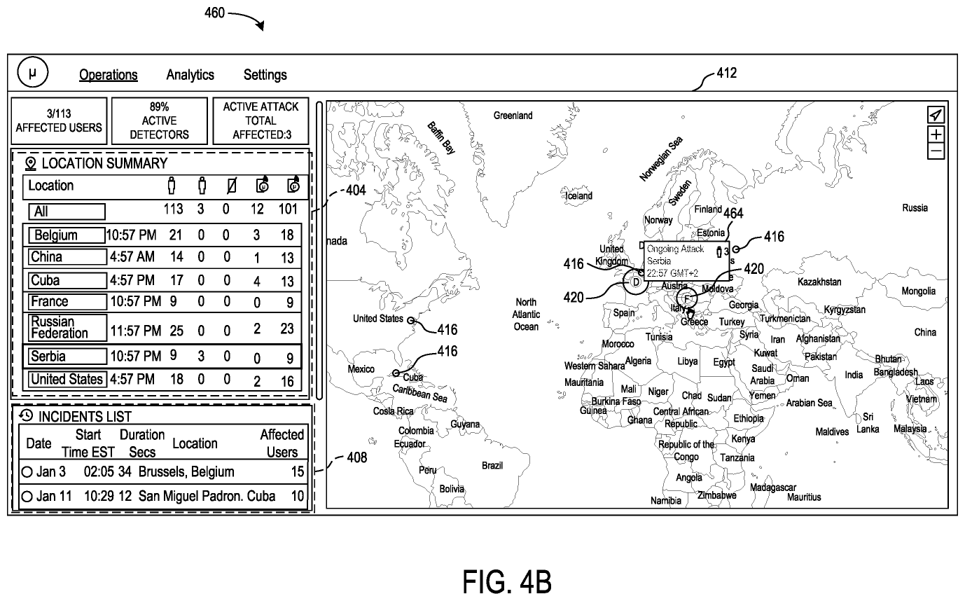

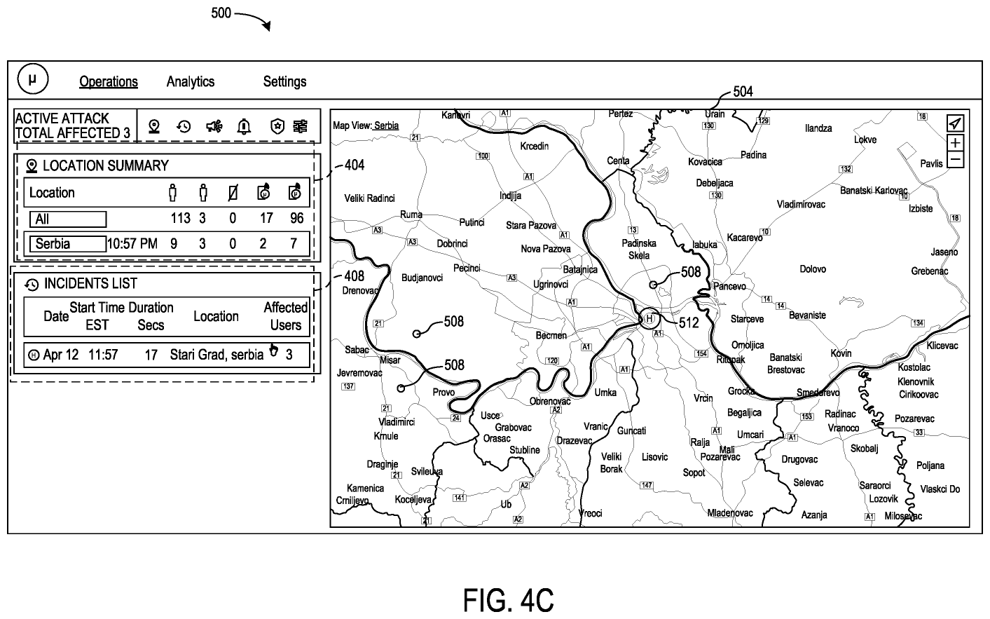

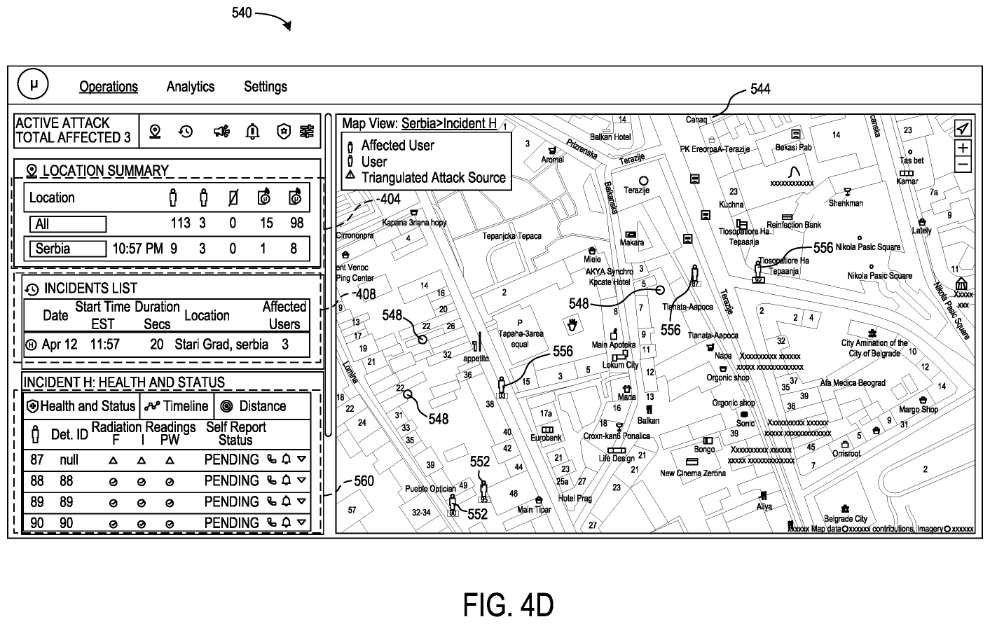

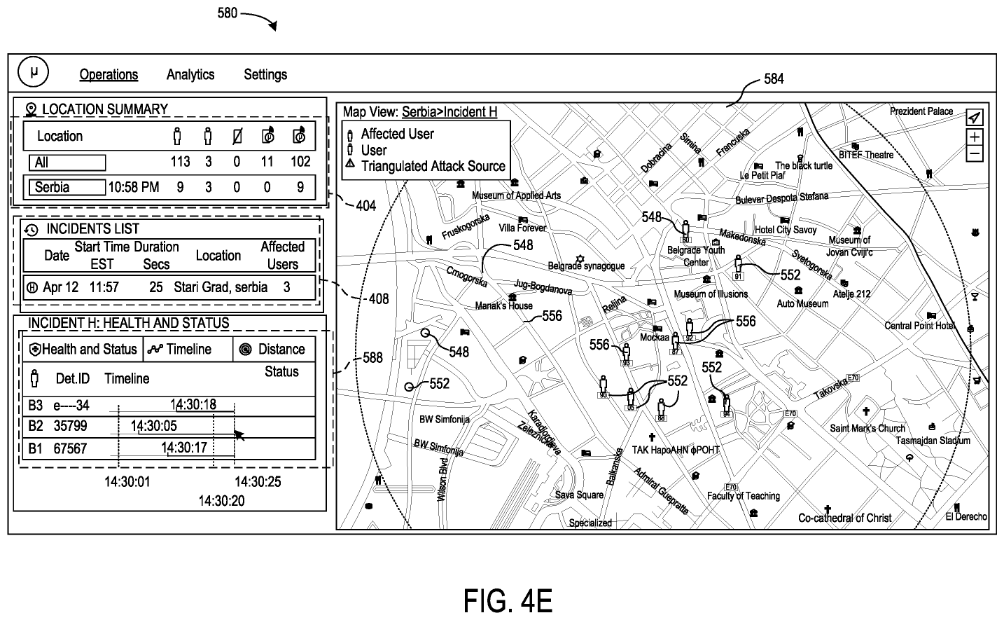

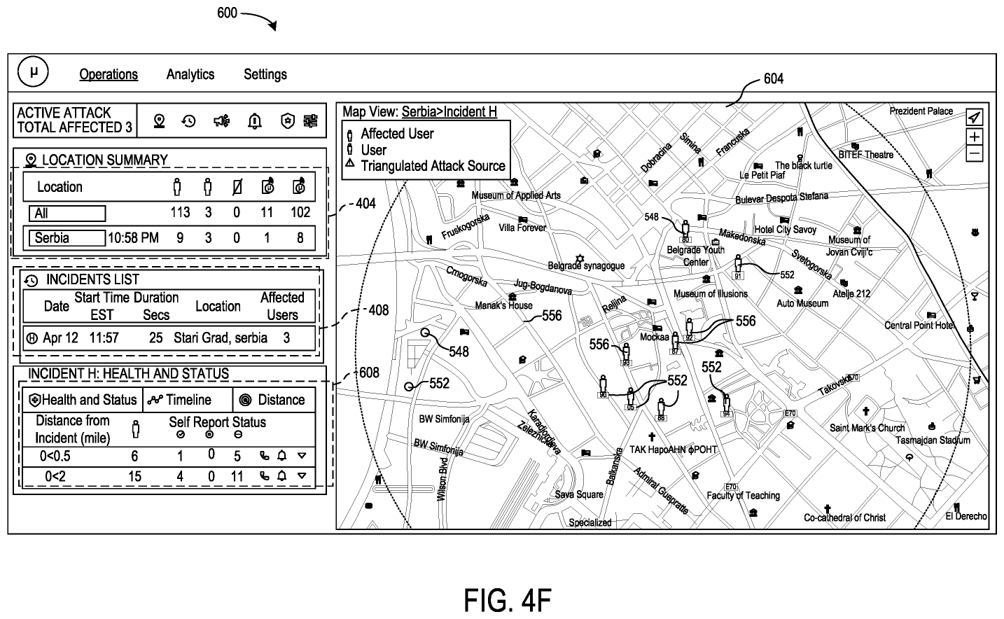

As noted, the dashboard 160 generated by the GUI generator 156 is accessible by the end-user device 164 (e.g., through a web browser). The dashboard 160 provides a real-time status (e.g., within 10 minutes) of the presence or absence of any threat detected, including the threat 104. FIGS. 4A-4F illustrate a sequence of webpages for the dashboard 160 that could be provided, for example, in response to detecting a threat or multiple threats.

FIG. 4A illustrates a first screenshot 400 of a dashboard (e.g., the dashboard 160 of FIG. 1) that could be output by an end-user device (e.g., the end-user device 164 of FIG. 1). The first screenshot includes a location summary 404. The location summary 404 includes a list of locations and a current status of wearable detectors (e.g., the wearable detectors 116 of FIG. 1) at or around each such location. The status includes a battery level and an indicia (e.g., an icon) indicating a number of wearable detectors in each area that detect a threat and the number of wearable detectors that do not detect a threat.

In the example location summary 404 provided, it is shown that a threat is detected by 3 wearable detectors near Serbia, and 9 wearable detectors or stationary detectors at or near Serbia do not detect a threat. Thus, in the example illustrated, a threat analyzer (e.g., the threat analyzer 148 of FIG. 1) notifies a threat detection application (e.g., the threat detection application 128 of FIG. 1) operating on the corresponding mobile device (e.g., one of the mobile devices 120 of FIG. 1) that the corresponding wearable detector detected a threat (e.g., the threat 104 of FIG. 1) and that a sensitivity level of measurement of the emissions is to be increased from a first level to a second level. Additionally, the threat analyzer notifies the mobile devices corresponding to the 9 wearable detectors and/or stationary detectors proximate to Serbia that are not reporting detection of the threat that a threat has in fact been detected, and that a sensitivity level of the measurements of the emissions is to be increased from the first level to the second level.

Additionally, the first screenshot 400 includes an incident list 408 that characterizes recently recorded threats based on data stored in a database (e.g., the database 152 of FIG. 1) that are within the field of view of a map 404. The incident list 408 includes a start time of the threat, a duration of the detected threat and a number of affected users during the corresponding threat.

Further, the first screenshot 400 includes the map 412 that includes icons indicating a status of wearable detectors in a given area. In the example illustrated, icons 416 with a first color (e.g., green) are provided. Additionally, icons 420 with a second color (e.g., red) and/or other indicia (e.g., expanded, flashing, etc.) are indicative of a region where a threat is currently being detected. In the example illustrated, one icon 420 is situated near Serbia, the location indicated in the location summary 404 for which a current threat is detected. Additionally, another icon 420 near France indicates that a threat has recently been detected, as indicated by the incident list 408.

FIG. 4B illustrates a second screenshot 460 wherein a user has hovered over the icon 420 near Serbia on the map 412 using a virtual cursor (e.g., a mouse or finger on a touch screen). In response to the hovering, a small window 464 displays additional details about the current threat, including a start time of the current threat and a number of wearable detectors that detected the threat.

FIG. 4C illustrates a third screenshot 500 wherein the icon 420 near Serbia in the screenshot 460 has been selected and actuated (e.g., clicked or virtually pressed). In the third screenshot 500 a smaller (by geographic region) map 504 is displayed that includes only a geographic area of Serbia (rather than multiple continents). The map 504 also includes additional icons 508 of the first color (e.g., green) and an icon 512 of the second color (e.g., red). The icons 508 of the first color correspond to regions within the map 504 where no threat is detected, and the icon 512 of the second color identifies a region within the map 504 where a threat is detected.

FIG. 4D illustrates a fourth screenshot 540 where the icon 512 of FIG. 4C has been selected. The fourth screenshot 540 includes a map 544. The map 544 is a street-level map covering a relatively small geographic area. The map 544 includes icons 548 of the first color (e.g., green) that represent individual stationary detectors (e.g., and instance of the stationary detector 124 of FIG. 1) for which no threat is detected. The map 544 also includes icons 552 of the first color that represent individual wearable detectors (e.g., one of the wearable detectors 116 of FIG. 1). Further, the map 544 includes icons 556 of the second color (e.g., red) that represent individual wearable detectors for which a threat has been detected (e.g., through threat data). In response to detecting the threat, the threat detection applications associated with the detectors corresponding to the icons 552 and the icons 556 are provided a warning that a threat has been detected in a proximate area, and that a measurement sensitivity level is increased from the first level to the second level.

The fourth screenshot 540 also includes a health and status category 560 of a menu that provides user specific information about individual wearers of wearable detectors. The health and status category 560 includes information characterizing a reported health status of the individual wearers and an icon (e.g., an icon of a telephone) for contacting the individual wearers.

FIG. 4E illustrates a fifth screenshot 580 with a map 584 (e.g., a street level map) wherein a timeline category 588 of a menu is selected. The timeline category 588 gives information characterizing the timeline for when individual wearable detectors or stationary detectors detected emissions from a threat and also show (if available) a time when the wearable detectors stopped detecting emissions from the threat.

FIG. 4F illustrates a sixth screenshot 600 with a map 604 (e.g., another street level map), wherein a distance category 608 of a menu is selected. The distance category 608 gives a distance from a wearable detector that has detected a threat.

Referring back to FIG. 1, as demonstrated by FIGS. 4A-4F, real-time (e.g., within 10 minutes) information characterizing a current status of a detected threat can be accessed by a user of the end-user device 164. Moreover, in some examples, the dashboard 160 and the threat analyzer 148 can be employed to extract historical information from the database 152 that is employable in forensics to identify the threat 104 (e.g., identify a source and location of the threat 104), and the threat analyzer 148 can query the database 152 to identify previous (historical threats) that have the same signature. For instance, in situations where 3 or more detectors (e.g., wearable detectors 116 and/or stationary detectors 124) detect a threat, the threat analyzer 148 can employ triangulation to determine a location of the threat 104. Furthermore, because the threat data is timestamped and includes a signature of the threat 104, during a forensics investigation, video footage captured by cameras (e.g., cameras of surveillance systems) in the vicinity of the wearable detectors 116 and/or the stationary detector 124 can be examined to reveal the location and the identity of the threat 104. For instance, suppose that the threat 104 has a unique signature, and the video recorded by cameras of a surveillance system near a detected threat reveal that a specific automobile (e.g., a van) is present in the vicinity each time the same signature of the threat 104 is detected. In this instance, there is an increased likelihood that the threat 104 is located within this vehicle.

Accordingly, by implementing the system 100, the location and identify of the threat 104 may be able to be determined. The system 100 enables constant monitoring of emissions of the threat 104 that are employable to detect the presence or the absence of the threat at a particular time. Furthermore, the communication protocol between the threat detection application 128 and the threat analyzer 148 is agnostic to a particular type of threat. Stated differently, the threat detection application 128 and the threat analyzer 148 are easily modified to accommodate a variety of threats, including the aforementioned RF emissions, radiation emissions, poisonous gas and/or any future detectable emissions and/or exposures from potential threats. Accordingly, the system 100 enables authorities to identify the location and source of the threat 104 both in real-time (e.g., while the threat is occurring) and/or forensically through the use of historical data stored in the database 152 such as the timestamp and/or signature of the threat 104.

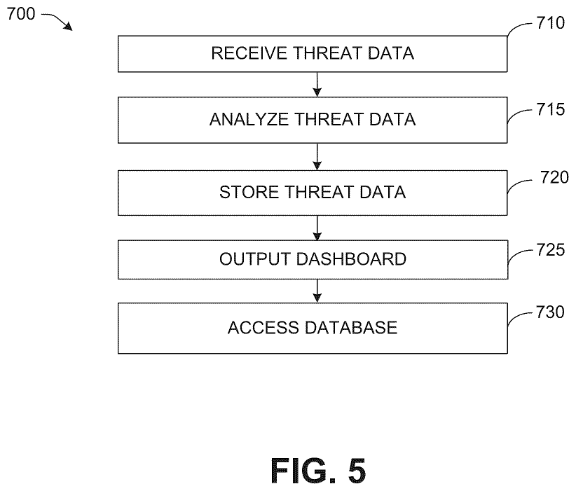

In view of the foregoing structural and functional features described above, an example method will be better appreciated with reference to FIG. 5. While, for purposes of simplicity of explanation, the example method of FIG. 5 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method.

FIG. 5 illustrates a flowchart of an example method 700 for monitoring the presence and/or absence of a threat from emission that could cause harm to humans. The method 700 could be executed, for example, by a server (e.g., a computing platform), such as the server 136 of FIG. 1.

At 710, the server receives threat data measured by stationary detectors and wearable detectors. The threat data characterizes a status of detected emissions and/or exposures for a corresponding stationary detector (e.g., a stationary detector 124 of FIG. 1) or a corresponding wearable detector (e.g., a wearable detector 116 of FIG. 1). At 715, the server analyzes the threat data to identify a geographic region that contains a given threat and to determine a signature of the threat to humans. At 720, the server stores the threat data and analyzed data in a database. At 725, the server outputs a dashboard (e.g., a webpage) that provides an interactive map with indicia that characterizes the analyzed threat data.

At 730, the server accesses the database to identify other threats with the same signature as the given threat. For instance, suppose that the given threat represents RF emissions with a particular frequency and pulse width. In such a situation, the signature of the threat could include the frequency and pulse width of the RF emissions. Thus, the server can retrieve historical threat data that reveals a time and location and associated with threat that have the same (or nearly the same) signature, and such information may be employed, for example, in a forensics analysis to identify a location and a source of the threat.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A system for monitoring operations of a computing platform comprising:
a non-transitory memory for storing machine readable instructions; and
a processing unit that accesses the memory and executes the machine readable instructions, the machine readable instructions comprising:
a threat analyzer that:
receives threat data measured by detectors, wherein the threat data characterizes a status of detected emissions for a corresponding detector;
analyzes the threat data to identify a geographic region that contains a threat to humans;
stores the threat data and analyzed data in a database; and
a graphical user interface (GUI) generator that provides an interactive map with indicia that characterizes the analyzed threat data.

2. The system of claim 1, wherein the threat analyzer further:
identifies a subset of the detectors proximate to the threat; and
increases a measurement sensitivity level for the subset of the detectors.

3. The system of claim 1, wherein the threat corresponds to a radio frequency (RF) emitter that provides a pulsed RF signal at a selected frequency.

4. The system of claim 3, wherein the selected frequency is between about 150 megahertz (MHz) and about 1.5 gigahertz (GHz).

5. The system of claim 3, wherein the analyzing includes determining a signature of the threat that identifies a pulse width and the selected frequency of the threat.

6. The system of claim 5, wherein the threat is a given threat, and the analyzer accesses the database to identify other detected threats that have a same signature as the given threat.

7. The system of claim 1, wherein the threat corresponds to a radioactive source or toxic chemical emitter.

8. The system of claim 1, wherein a first subset of the detectors comprise wearable detectors that communicate with mobile computing devices and a second subset of the detectors comprise stationary detectors.

9. The system of claim 1, wherein the threat analyzer triangulates a location of the threat based on the threat data measured by three or more of the detectors.

10. The system of claim 9, wherein the interactive map is provided as a webpage.

11. The system of claim 1, wherein the interactive map includes icons representing a location and a status of detectors in a selected geographic area.

12. The system of claim 1, wherein the detectors are distributed in multiple continents of earth.

13. A non-transitory machine readable medium having machine executable instructions executable by a processing unit, the machine executable instructions comprising:
a threat analyzer that:
receives threat data measured by stationary detectors and wearable detectors, wherein the threat data characterizes a status of detected emissions for a corresponding stationary detector or a corresponding mobile detector;
analyzes the threat data to identify a geographic region that contains a threat to humans;
stores the threat data and analyzed data in a database; and
a graphical user interface (GUI) generator that provides an interactive map with indicia that characterizes the analyzed threat data.

14. The medium of claim 13, wherein the threat analyzer further:
identifies a subset of the detectors proximate to the threat; and
increases a measurement sensitivity level for the subset of the detectors in response to the detection.

15. The medium of claim 13, wherein the threat corresponds to a source of radio frequency (RF) emissions that provides a pulsed RF signal at a selected frequency.

16. The medium of claim 15, wherein the analyzing includes determining a signature of the threat that identifies a pulse width and the selected frequency of the threat.

17. The medium of claim 16, wherein the threat is a given threat, and the analyzer accesses the database to identify other detected threats that have a same signature as the given threat.

18. A method comprising:
receiving, at a computing platform, threat data measured by stationary detectors and mobile detectors, wherein the threat data characterizes a status of detected emissions for a corresponding stationary detector or a corresponding mobile detector;
analyzing, by the computing platform, the threat data to identify a geographic region that contains a threat to humans and to determine a signature of the threat;
storing, by the computing platform, the threat data and analyzed data in a database; and
outputting, by the computing platform, a dashboard that provides an interactive map with indicia that characterizes the analyzed threat data.

19. The method of claim 18, wherein the threat is a given threat, the method further comprising, accessing, by the computing platform, the database to identify other threats with a same signature as the given threat.

20. The method of claim 18, wherein the threat is a pulsed radio frequency (RF) signal at a selected frequency.
